(19) United States
(12) Patent Application Publication
(10) Pub. No.: US 2026/0307008 A1
(43) Pub. Date: Oct. 8, 2026

(54) Air Treatment System

(71) Applicants: UNIVERSITEIT ANTWERPEN, Antwerpen (BE); VENTO NV, Oudenaarde (BE)

(72) Inventors: Siegfried Denys, Antwerpen (BE); Jelle Roegiers, Antwerpen (BE); Kristof Vaes, Antwerpen (BE); Bart Modde, Antwerpen (BE); Kobe Schoofs, Antwerpen (BE); Alexander Van Gastel, Antwerpen (BE)

(21) Appl. No.: 19/482,475

(22) PCT Filed: May 8, 2024
(86) PCT No.: PCT/EP2024/062775

§ 371 Date: Nov. 7, 2025

(30) Foreign Application Priority Data
May 9, 2023 (EP) 23172439.4

(51) Int. Cl. B01D 53/88; F24F 8/108; F24F 11/39

(52) U.S. Cl. CPC B01D 53/885; F24F 8/108; F24F 11/39; B01D 2257/708; B01D 2258/06; B01D 2259/804

(57) ABSTRACT

There is described an air treatment system (10) and method for filtering volatile organic compounds. The air processing circuit (100) comprises a filter module (200) configured to remove volatile organic compounds and a filter regeneration module (300). The air processing circuit (100) is configured to be selectively operatable in an air purification mode (130) and a filter regeneration mode (140).

### CROSS REFERENCE TO RELATED APPLICATIONS

This application is a national phase entry under 35 U.S.C. § 371 of International Patent Application PCT/EP 2024/062775, filed May 8, 2024, designating the United States of America and published in English as International Patent Publication WO 2024/231471 on Nov. 14, 2024, which claims the benefit under Article 8 of the Patent Cooperation Treaty to European Patent Application Serial No. 23172439.4, filed May 9, 2023, the entireties of which are hereby incorporated by reference.

### FIELD OF THE INVENTION

There is described a system and method related to the technical field of the treatment of air, also referred to as an air purification systems and methods. More specifically the described air treatment system and method are directed removing volatile organic compounds or VOCs from the air.

### BACKGROUND

Indoor air quality is of major concern in maintaining health of people spending a significant part of the day indoors. Important indoor pollutants are CO₂ and volatile organic compounds (VOC), both hazardous to the health of people residing in buildings. CO₂ is mainly produced by people residing in the building in exhaled breath. VOCs for the most part originate by evaporation from materials present in the building, such as paints.

It is of prime importance to ensure that such pollutants are removed, typically by adequate ventilation. In particular in current times, buildings become more and more insulated, such that natural ventilation is minimized. To this end, artificial ventilation systems are used to compensate for the lack of natural ventilation. A major drawback of ventilation systems, especially during cold periods, is that cold outside air enters the building and needs to be heated and that heated indoor air is expelled outside, leading to heat loss. The inverse is also true during warm periods. Ventilation systems therefore put a high burden on energy consumption.

As an alternative to and/or in addition to ventilation, it can be considered to filter indoor air in order to remove pollutants. In this way, heat losses are minimized, and as a consequence energy consumption is likewise minimized. Air filtration however, also comes with its own disadvantages. Activated carbon filters can be used to filter for instance VOC. Once saturated however, these filters typically need to be replaced, thereby counterproductively increasing the need for maintenance and downtime of the system again. Alternatively, VOC can be filtered by photocatalytic reactors, which on their own also pose a major burden on energy consumption and byproduct formation.

There thus exists a need for a system and method for the treatment of air which overcomes the abovementioned disadvantages and is more safe, efficient, simple, robust, user friendly, energy efficient and low maintenance.

### SUMMARY

There is advantageously realized an air filtration method and system which overcomes the disadvantages of contemporary air filtration systems. This in particular relates to an air filtration system and related methods for air filtration in which a combination of filtration modules, and in particular a specific arrangement and operation of filtration modules advantageously and surprisingly synergistically results in superior energy-efficient and low maintenance air filtration.

According to a first aspect, there is provided an air treatment system for filtering volatile organic compounds, the air treatment system comprising an air processing circuit for receiving input air and outputting filtered output air comprising:
a filter module configured to remove volatile organic compounds; and
a filter regeneration module, in particular comprising a photocatalytic reactor, such as a photocatalytic oxidation (PCO) reactor, and

the air processing circuit configured to be selectively operatable in:
an air purification mode, during which the air processing circuit is configured:
   to accept the input air and feed the input air to the filter module, and
   to feed the filtered air from the filter module to provide the filtered output air; and
a filter regeneration mode, during which the air processing circuit is configured:
   not to accept the input air and not to provide the filtered output air, and
   to couple the filter module to the filter regeneration module, whereby the filter regeneration module is operated to remove and/or reduce at least a part of the accumulated volatile organic compounds from the filter module.

As the regeneration module is only operated in the filter regeneration mode, the power consumption will be lower as compared to a continuous operation of such a regeneration module. Further the filter regeneration mode allows for low maintenance operation of the air treatment system, in which the operational life of the filter is increased and the need for replacement of the filter is reduced, which also increases the user friendliness of the system. Further, in the air purification mode, the airflow can be optimized to the optimal capacity of the filter module, thereby allowing an optimal efficiency and throughput for removing the volatile organic compounds from the air flow. The filter module consumes less energy than the regeneration module. The regeneration mode allows a safe release of VOCs from the filter and reduces the risk that these released VOCs- or possible by-products generated by the filter regeneration module during regeneration-will be outputted by the air treatment system as part of the filtered output air. Accordingly, the air treatment system of the invention greatly reduces the amount of pollutants such as VOCs, generated indoors which will be released in the outdoor environment. The filter regeneration module can also be operated in ideal conditions to remove VOCs from the filter and to reduce the amount of removed VOCs in the air processing circuit, independent of for example the air flow needs during the air purification mode.

According to a second aspect, there is provided a method of operating an air treatment system according to the first aspect, wherein the method comprises the steps of: selectively operating the air processing circuit in:
an air purification mode, during which the air processing circuit:
   accepts the input air and feeds the input air to the filter module, and
   provides the filtered output air by feeding the filtered air from the filter module; and
a filter regeneration mode, during which the air processing circuit:
   does not accept the input air and does not provide the filtered output air, and
   couples the filter module to the filter regeneration module, whereby the filter regeneration module is operated to remove and/or reduce at least a part of the accumulated volatile organic compounds from the filter module.

According to a third aspect, there is provided a ventilation system, heating system, air conditioning system, or HVAC system comprising the air treatment system according to the first aspect.

According to a fourth aspect, there is provided the use of the air treatment system according to the first aspect in a ventilation system, heating system, air conditioning system, or HVAC system.

According to a fifth aspect, there is provided a data processing device comprising means for carrying out the steps of the method of the second aspect. It is to be understood that the data processing device operates or instructs the air treatment system and hence requires an operational connection.

According to a sixth aspect, there is provided a computer program product comprising instructions which, when the program is executed by a computer, cause the computer to carry out the method of the second aspect.

According to a seventh aspect, there is provided a computer-readable data carrier comprising instructions which, when the executed by a computer, cause the computer to carry out the method of the second aspect.

### BRIEF DESCRIPTION OF THE DRAWINGS

Exemplary embodiments will now be described by means of the drawings in which:

FIG. 1 schematically shows an embodiment of an air processing circuit of an air treatment system when operating in an air purification mode;

FIG. 2 schematically shows an embodiment of FIG. 1 when operating in a filter regeneration mode;

FIG. 3 schematically shows an embodiment of a method of operating an embodiment of an air processing circuit of an air treatment system similar to the embodiment of FIG. 1;

FIG. 4 shows the acetaldehyde concentration inside active carbon filter/photocatalytic oxidation reactor (ACF/PCO reactor) during the different modes of operation according to an embodiment of the invention.

FIG. 5 shows the simulated pollutant concentration curves obtained when using an air treatment device according to an embodiment of the invention.

FIG. 6 shows the experimental pollutant concentration curves obtained when using an air treatment device according to an embodiment of the invention.

FIG. 7 shows the simulated pressure drop curves for parallel and pleated filter design.

### DESCRIPTION

Before the present system and method of the invention are described, it is to be understood that this invention is not limited to particular systems and methods or combinations described, since such systems and methods and combinations may, of course, vary. It is also to be understood that the terminology used herein is not intended to be limiting, since the scope of the present invention will be limited only by the appended claims.

As used herein, the singular forms “a”, “an”, and “the” include both singular and plural referents unless the context clearly dictates otherwise.

The terms “comprising”, “comprises” and “comprised of” as used herein are synonymous with “including”, “includes” or “containing”, “contains”, and are inclusive or open-ended and do not exclude additional, non-recited members, elements or method steps. It will be appreciated that the terms “comprising”, “comprises” and “comprised of” as used herein comprise the terms “consisting of”, “consists” and “consists of”, as well as the terms “consisting essentially of”, “consists essentially” and “consists essentially of”.

The recitation of numerical ranges by endpoints includes all numbers and fractions subsumed within the respective ranges, as well as the recited endpoints.

The term “about” or “approximately” as used herein when referring to a measurable value such as a parameter, an amount, a temporal duration, and the like, is meant to encompass variations of +/−20% or less, preferably +/−10% or less, more preferably +/−5% or less, and still more preferably +/−1% or less of and from the specified value, insofar such variations are appropriate to perform in the disclosed invention. It is to be understood that the value to which the modifier “about” or “approximately” refers is itself also specifically, and preferably, disclosed.

Whereas the terms “one or more” or “at least one”, such as one or more or at least one member(s) of a group of members, is clear per se, by means of further exemplification, the term encompasses inter alia a reference to any one of said members, or to any two or more of said members, such as, e.g., any ≥3, ≥4, ≥5, ≥6 or ≥7 etc. of said members, and up to all said members.

All references cited in the present specification are hereby incorporated by reference in their entirety. In particular, the teachings of all references herein specifically referred to are incorporated by reference.

Unless otherwise defined, all terms used in disclosing the invention, including technical and scientific terms, have the meaning as commonly understood by one of ordinary skill in the art to which this invention belongs. By means of further guidance, term definitions are included to better appreciate the teaching of the present invention.

In the following passages, different aspects of the invention are defined in more detail. Each aspect so defined may be combined with any other aspect or aspects unless clearly indicated to the contrary. In particular, any feature indicated as being preferred or advantageous may be combined with any other feature or features indicated as being preferred or advantageous.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may do so. Furthermore, the particular features, structures or characteristics may be combined in any suitable manner, as would be apparent to a person skilled in the art from this disclosure, in one or more embodiments. Furthermore, while some embodiments described herein include some, but not other features included in other embodiments, combinations of features of different embodiments are meant to be within the scope of the invention, and form different embodiments, as would be understood by those in the art. For example, in the appended claims, any of the claimed embodiments can be used in any combination.

In the following detailed description of the invention, reference is made to the accompanying drawings that form a part hereof, and in which are shown by way of illustration only of specific embodiments in which the invention may be practiced. It is to be understood that other embodiments may be utilised, and structural or logical changes may be made without departing from the scope of the present invention. The following detailed description, therefore, is not to be taken in a limiting sense, and the scope of the present invention is defined by the appended claims.

Preferred statements (features) and embodiments of this invention are set herein below. Each of the statements and embodiments of the invention so defined may be combined with any other statement and/or embodiment unless clearly indicated to the contrary. In particular, any feature indicated as being preferred or advantageous may be combined with any other feature or features or statements indicated as being preferred or advantageous.

As used herein, the term “volatile organic compound” or “VOC” has its ordinary meaning known in the art. By means of further guidance, and without limitation, VOC refers to organic chemicals, i.e. comprising carbon) that have a high vapour pressure at room temperature. VOC include such compounds (excluding carbon monoxide, carbon dioxide, carbonic acid, metallic carbides or carbonates, and ammonium carbonate), which participates in atmospheric photochemical reactions.

According to a first aspect, there is provided an air treatment system for filtering volatile organic compounds, the air treatment system comprising an air processing circuit for receiving input air and outputting filtered output air comprising:
a filter module configured to remove volatile organic compounds; and
a filter regeneration module, in particular comprising a photocatalytic reactor, such as a photocatalytic oxidation reactor, and

the air processing circuit configured to be selectively operatable in:
an air purification mode, during which the air processing circuit is configured:
   to accept the input air and feed the input air to the filter module, and
   to feed the filtered air from the filter module to provide the filtered output air; and
a filter regeneration mode, during which the air processing circuit is configured:
   not to accept the input air and not to provide the filtered output air, and
   to couple the filter module to the filter regeneration module, whereby the filter regeneration module is operated to remove and/or reduce at least a part of the accumulated volatile organic compounds from the filter module.

According to an embodiment, there is provided an air treatment system, wherein the air processing circuit is further configured such that:
in the air purification mode the filter regeneration module is:
   deactivated;
   decoupled from the filter module; and/or
   decoupled from the input air and/or the filtered output air; and
in the filter regeneration mode the filter regeneration module is:
   activated;
   coupled to the filter module; and/or
   decoupled from the input air and/or the filtered output air.

In this way a simple and energy efficient operation is possible as the filter regeneration module only needs to be activated during the filter regeneration mode and thus only consumes energy needed for a filter regeneration operation during this time period. When during the air purification mode the filter regeneration module is deactivated, this will reduce the overall energy consumption of the air processing circuit as compared to embodiments in which the filter regeneration module is operated on a continuous basis. In this way also a more safe operation is provided for as there is a reduced risk of any pollutants extracted from the filter module by the filter regeneration module being mixed with the input air or the filtered output air as the filter regeneration module is preferably decoupled from the filter module during the air purification mode. Preferably the filter regeneration module is also preferably decoupled from the input air and the filtered output air during both the air purification mode and the filter regeneration mode.

According to an embodiment, there is provided an air treatment system, wherein the air processing circuit is further configured such that:
in the air purification mode the filter module is:
   decoupled from the filter regeneration module; and/or
   coupled to the input air and/or the filtered output air; and
in the filter regeneration mode the filter module is:
   coupled to the filter regeneration module; and/or
   decoupled from the input air and/or the filtered output air.

In this way a safer operation of the system is ensured as there is a reduced risk of any pollutants extracted from the filter module by the filter regeneration module being mixed with the input air or the filtered output air as the filter module is preferably decoupled from input air and the filtered output air during the filter regeneration mode. A more safe and energy efficient operation is also assured as in the air purification mode, the filter module is decoupled from the filter regeneration module, which reduces the risk of any remaining pollutants in the regeneration module to circle back to the filtering module 200 and which reduces the number of modules of the air processing circuit through which the airflow actively flows, and thus reduces the resistance associated with such components for the airflow, thereby reducing the energy needed for generating this airflow.

According to a further embodiment, there is provided an air treatment system, wherein the air processing circuit comprises a valve system coupled to the filter module and the filter regeneration module, and configured such that:
in the air purification mode the valve system is set in a first state, in which the valve system:
   decouples the filter module from the filter regeneration module; and/or
   couples the filter module to the input air and/or the filtered output air; and
in the filter regeneration mode the valve system is set in a second state, in which the valve system:
   couples the filter module to the filter regeneration module; and/or
   decoupled the filter module from the input air and/or the filtered output air.

In this way a simple, safe and effective air processing circuit can be realized.

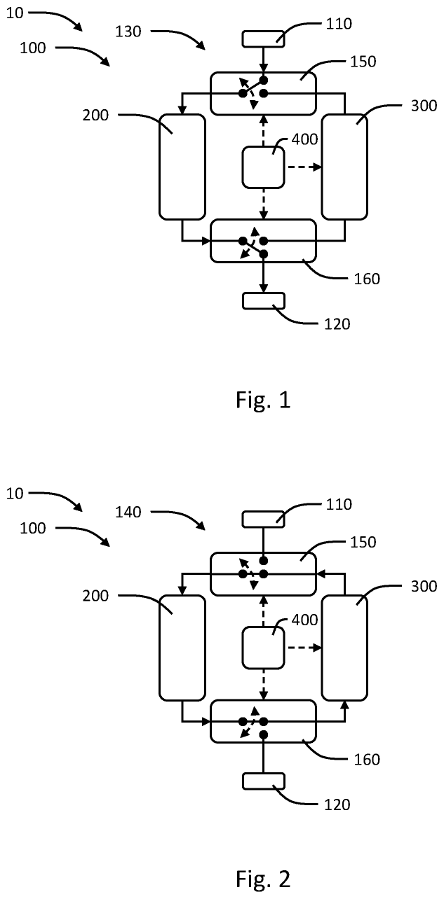

According to the embodiment schematically shown in FIG. 1 and FIG. 2, there is provided an air treatment system 10 for filtering volatile organic compounds. It is clear that the air treatment system could, in addition to volatile organic compounds or VOCs, optionally also filter, remove and/or reduce also other harmful and/or undesired substances from the air such as for example any other volatile chemicals and/or contaminants, dust, pollen, mold, bacteria, odors, smoke, . . . . As schematically shown, the embodiment of the air treatment system 10 comprises an air processing circuit 100 for receiving input air 110 and outputting filtered output air 120.

According to some embodiments the input air 110 could for example be air being taken from a space or room of which the air is in need of treatment by the air treatment system. According to alternative embodiments, the input air 110 could for example air being taken from a source of outside air, which is in need of treatment by the air treatment system before being fed into a space or room. It is clear that still further alternative embodiments are possible, in which for example the input air 110 originates from any suitable indoor and/or outdoor space, and is fed for input to the air treatment system 10 in any suitable way, or any other suitable alternative embodiment.

According to some embodiments the filtered output air 120 outputted by the air treatment system 10 could for example be air being fed to a space or room of which the input air was extracted for treatment by the air treatment system 10. According to alternative embodiments, the filtered output air 120 could for example be air taken from a source of outside air, which was treated by the air treatment system before being fed into a space or room. It is clear that still further alternative embodiments are possible, in which for example the filtered output air 120 originates from any suitable indoor and/or outdoor space in which for example volatile pollutants are present, and which was filtered by the air treatment system 10 before being released int the outside air, or any other suitable alternative embodiment.

As further show in FIG. 1 and FIG. 2, the embodiment of the air processing circuit 100 comprises a filter module 200 and a filter regeneration module 300. Such a filter module 200 is preferably configured to remove volatile organic compounds. Such a filter regeneration module 300, when activated is configured to remove and/or reduce at least a part and preferably all of the accumulated volatile organic compounds from the filter module 200.

As shown in the embodiment of FIG. 1 and FIG. 2 the air processing circuit 100 is selectively operatable in an air purification mode 130 and a filter regeneration mode 140. As will be explained in further detail below, according to the embodiment shown, selectively means that the air purification mode 130 and the filter regeneration mode 140 are for example of a sequential nature, and preferably the time period in which the air processing circuit 100 is operated in the filter regeneration mode 140 of FIG. 2, does not coincide, or in other words is different from or does not overlap with, the time period in which the air processing circuit 100 is operated in the air purification mode 130. It is clear that alternative embodiments are possible in which there is for example at least a partial overlap of the air purification mode 130 of one filter module 200 and the filter regeneration mode 140 of another filter module 200 of an embodiment of an air processing circuit 100 comprising a plurality of filter modules 200. However, it is clear that for each, individual filter module 200, the air processing circuit 100, is preferably not operatable in both the air purification mode 130 and the filter regeneration mode 140.

As schematically shown in FIG. 1, according to the embodiment of the air processing circuit 100, when operated in the air purification mode 130, the air processing circuit 100 accepts the input air 110 and feeds the input air 110 to the filter module 200. The air processing circuit 100, during the air purification mode 130 shown in FIG. 1 then feeds the filtered air from the filter module 200 further along the air processing circuit 100 to provide it as filtered output air 120.

As schematically shown in FIG. 2, according to the embodiment of the air processing circuit 100, when operated in the filter regeneration mode 140, the air processing circuit 100 does not accept the input air 110 and does not provide the filtered output air 120. In other words, in the filter regeneration mode 140 the air processing circuit 100 decouples the filtering module 200 from the input air 110 and the output air 120. In other words, in the filter regeneration mode 140, there is no longer a flow path between the filtering module 200 and a port accepting the input air 110 and/or a port providing the output air 120 of the air processing circuit 100. As further schematically shown in FIG. 2, in the filter regeneration mode 140 of the embodiment of the air processing circuit 100, the filter module 200 is coupled to the filter regeneration module 300. In the filter regeneration mode 140, the filter regeneration module 300 of the air processing circuit is activated to remove and/or reduce at least a part of the accumulated volatile organic compounds from the filter module 200. According to the embodiment shown in FIG. 2, it is clear that, when in the filter regeneration mode 140, the air processing circuit 100 preferably couples the filter module 200 and the filter regeneration module 300 in a closed circuit, such that an air flow can circulate from the filter module 200 to the filter regeneration module 300 and to the filter module 200 again. In other words, in the filter regeneration mode 140, the filter module 200 and the filter regeneration module 300 are coupled in series, in a closed-loop configuration, with respect to the air flow in the embodiment of the air processing circuit 100 shown in FIG. 2.

As further schematically shown in the embodiment of FIG. 1 and FIG. 2, the air processing circuit 100 comprises a valve system 150,160 coupled to the filter module 200 and the filter regeneration module 300. As shown, according to this embodiment, the valve system 150, 160 comprises an inlet valve system 150 configured for selectively coupling the filter module 200 to the input air 110 in the state of FIG. 1 or the filter regeneration module 300 in the state of FIG. 2. As further shown, according to this embodiment, the valve system 150, 160 comprises an outlet valve system 160 configured for selectively coupling the filter module 200 to the output air 110 in the state of FIG. 1 or the filter regeneration module 300 in the state of FIG. 2. Although, according to the embodiment shown, the inlet valve system 150 and the outlet valve system 160 are schematically represented, each as a single valve configured to selectively couple one port to one of two other ports, it is clear that alternative embodiments of these valve systems 150, 160 are possible in which an identical and/or similar functionality is realized by means of one or more suitable coupled valves in the air processing circuit 10, as will for example be described in further detail below.

It is thus clear that, according to the embodiment of FIG. 1, in the air purification mode 130 the valve system 150, 160 is set in a first state, in which the valve system 150, 160 decouples the filter module 200 from the filter regeneration module 300; and couples the filter module 200 to the input air 110 and the filtered output air 120. As shown, according to this embodiment, this means that the inlet valve system 150 couples a first port of the filter module 200 to the inlet air 110 and the outlet valve system 160 couples a second port of the filter module 200 to the filtered outlet air 120. As further shown, according to this embodiment, in this first state, the inlet valve system 150 decouples a first port of the filter regeneration module from both the inlet air 110 and the filter module 200 and the outlet valve system 160 decouples a second port of the filter regeneration module 300 from both the filtered outlet air and the filter module 200.

According to the state of this embodiment shown in FIG. 2, in the filter regeneration mode 140, the valve system 150, 160 is set in a second state, in which the valve system 150, 160 couples the filter module 200 to the filter regeneration module 300. As further shown in FIG. 2, in this second state the valve system 150, 160 also decouples the filter module 200 from the input air 110 and the filtered output air 120. As shown, according to this embodiment, this means that the inlet valve system 150 couples the first port of the filter module 200 to the first port of the filter regeneration module 300 and the outlet valve system 160 couples the second port of the filter module 200 to the second port of the filter regeneration module 300. As further shown, according to this embodiment, in this second state, the inlet valve system 150 decouples the inlet air 110 from both the filter module 200 and the filter regeneration module, and the outlet valve system 160 decouples the filtered outlet air 120 from both the filter module 200 and the filter regeneration module 300.

As explained in further detail below, according to some embodiments the valve system 150, 160 could comprise valves which are manually and/or automatically operatable for selectively switching between the first state and the second state described above, thereby allowing to selectively set the operational mode of the air processing circuit 100 to the air purification mode 130 for example shown in FIG. 1 or alternatively to the filter regeneration mode for example shown in FIG. 2.

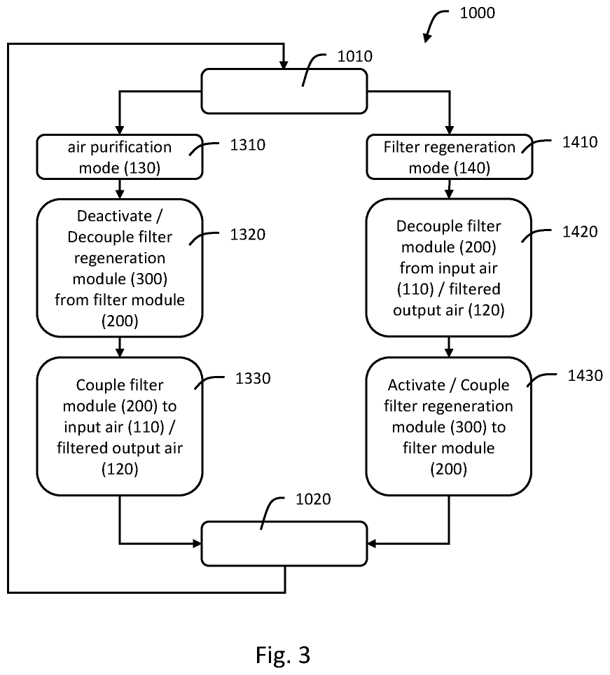

FIG. 3 schematically shows an embodiment of a method 1000 of operating an embodiment of an air processing circuit 100 of an air treatment system 10 similar to the embodiment of FIG. 1 and FIG. 2. As shown, the embodiment of the method 1000 of operating the embodiment of the air treatment system 10 is initiated at a method selection step 1010, in which there is selected one operational mode of the air processing circuit 100 from a plurality of operational modes comprising at least the air purification mode 130 and the filter regeneration mode 140, similar as for example described above with respect to FIG. 1 and FIG. 2. When in selection step 1010, the air processing circuit 100 is selected to operate in the air purification mode 130, the embodiment of the method of FIG. 3 continues to step 1310. When in selection step 1010, the air processing circuit 100 is selected to operate in the filter regeneration mode 140, then the method according to FIG. 3 continues to step 1410. The selection step 1010 according to one embodiment, could be a manual step, in which for example an operator manipulates one or more elements of the air processing circuit 100, or provides a suitable manual input to a controller 400 configured to control one or more elements of the air processing circuit 100, such as for example the valve system comprising one or more suitable valves 150, 160, to configure the air processing circuit 100 for operation either in the air purification mode 130 at step 1310 or in the filter regeneration mode 140 at step 1410. According to an alternative embodiment the controller 400 could be configured to control the elements of the air processing circuit 100 automatically, for example in function of suitable time-based and/or sensor-based control logic.

As further shown, according to the embodiment of FIG. 3, in the air purification mode 130, the method continues to step 1320 in which the filter regeneration module 300 is preferably deactivated, or if already deactivated kept in a deactivated state. Preferably, in step 1320 the filter regeneration module 300 is decoupled from the filter module 200, similar as described with respect to the embodiment of FIG. 1 above. As further shown, according to the embodiment of FIG. 3, the method then continues to step 1330 in which the filter module 200 is coupled to accept the input air 110, for example from a suitable port or inlet to accept input air 110, and the filter module 200 is also coupled to provide the filtered output air 120, for example to a suitable port or outlet to output the filtered output air 120, similar as described with respect to the embodiment of FIG. 1.

As further shown, according to the embodiment of FIG. 3, in the filter regeneration mode 140, the method continues to step 1420 in which the filter module 200 is decoupled from the input air 110, for example from a suitable port or inlet to accept input air 110, and the filter module 200 is also decoupled from the filtered output air 120, for example from a suitable port or outlet to output the filtered output air 120, similar as described with respect to the embodiment of FIG. 2. As further shown, according to the embodiment of FIG. 3, the method then continues to step 1430 in which the filter regeneration module 300 is preferably activated, or if already activated kept in an activated state. Preferably, in step 1430 the filter regeneration module 300 is coupled to the filter module 200, similar as described with respect to the embodiment of FIG. 2 above.

It is clear, that preferably, similar as described above with reference to FIG. 1 and FIG. 2, in both the air purification mode 130 and the filter regeneration mode 140, the filter regeneration module 300 remains decoupled from the input air 110, for example from a suitable port or inlet to accept input air 110, and the filter regeneration module 300 remains also decoupled from the filtered output air 120, for example from a suitable port or outlet to output the filtered output air 120.

The coupling and decoupling of the filter module 200 and/or the filter regeneration module 300 in the steps described above, could be performed manually or automatically.

As further shown, according to the embodiment of FIG. 3, the method then continues to step 1020 which for example returns the method to the selection step of 1010 for selecting a suitable operational mode of the air treatment circuit 100. Step 1020 according to one embodiment, could be a manual step, in which for example an operator determines manually when the current operational mode, such as for example the air purification mode 130 or the filter regeneration mode 140 is to be ended and selection of the operational mode of the air processing circuit 100 is to be performed again in step 1010, for example based on manual oversight of time-based parameters or sensor readings. According to an alternative embodiment, manual control could for example be implemented by means of providing suitable outputs from a controller 400 configured to alert the operator of the air processing circuit that the current operational mode needs to be ended and/or a new operational mode needs to be selected in step 1010. According to an alternative embodiment the controller 400 could be configured to control the end of the current operational mode and/or the progress to the selection of a new operational mode automatically, for example in function of suitable time-based and/or sensor-based control logic.

It is clear that alternative embodiments of the method 1000 are possible, in which during the air purification mode 130, the air processing circuit 100 accepts the input air 110 and feeds the input air 110 to the filter module 200, and provides the filtered output air 120 by feeding the filtered air from the filter module 200. According to such alternative embodiments of the method 1000, during the filter regeneration mode 140 the air processing circuit 100 does not accept the input air 110 and does not provide the filtered output air 120, and couples the filter module 200 to the filter regeneration module 300, whereby the filter regeneration module 300 is operated to remove and/or reduce at least a part of the accumulated volatile organic compounds from the filter module 200.

In this way a simple, safe and effective air processing circuit can be realized.

The filter module can comprise any means known in the art suitable for air filtration, in particular suitable for filtering VOCs. Typically, such means operate through adsorption of VOCs during the filtration process. It will be understood that such means typically are also capable of desorbing VOCs. Accordingly, in certain embodiments, the filtration module comprises means for adsorbing at least VOCs. In certain embodiments, the filtration module comprises means for desorbing at least VOCs. In certain embodiments, the filtration module comprises means for adsorbing and desorbing at least VOCs. Preferably, the filter is a regeneratable (gas) filter, such as heat-regeneratable (gas) filter, in particular a heat-regeneratable VOC filter.

Preferably, the filter module is heat-resistant. As used herein, the term heat-resistant implies that the filter module is capable of withstanding temperatures higher than room temperature, such as temperatures of at least 50 °C, such as at least 75 °C, without resulting in structural and/or functional damage, i.e. after exposure to temperatures of at least 50 °C, such as for instance at temperatures capable of desorbing VOC from the filter, the filter maintains its capability to adsorb VOCs again. The skilled person will understand that temperatures for desorbing particular VOCs may depend on the type of VOC, and adjust desorption temperatures accordingly. In certain embodiments, the filter module is resistant to heat at a temperature which is at least the temperature at which desorption of VOC occurs, which may be higher than room temperature, such as at least 50 °C or at least 75 °C

The skilled person will understand that the filter module is configured in such way as to ensure complete filtration of input air, i.e. filter by-passing of input air is prevented by appropriate fitting of the filter in the filter module, which may include use of suitable sealing means, such as (heat-resistant) rubber sealing means.

In a preferred embodiment, the filter module comprises one or more carbon filter, such as activated carbon filter. The (activated) carbon material may be a microporous (activated) carbon material with a fibre shape and a well-defined porous structure. Preferably, the filter comprises (activated) carbon fibres, in particular an (activated) carbon fibre cloth, sheet, or tube. The (activated) carbon fibres may be woven or non-woven. In certain embodiments, the (activated) carbon fibres are comprised in an (activated) carbon fibre felt. Preferably, the filter comprises a pleated (activated) carbon fibre cloth, sheet, or tube. A (activated) carbon fibre tube, as used in disclosing the present description, is a (activated) carbon fibre continuous sheet without ends, which may be cylindrical in shape. The skilled person will understand that the fibre cloth, sheet, or tube may be suitably affixed in a framework, armature, or housing, as is known in the art.

The skilled person will understand that (VOC) filters other than carbon filters may be applied according to alternative embodiments, such as for instance without limitation zeolite filters. Accordingly, the aspects and embodiments described herein in connection with carbon filters may suitably be adapted to such other filter types, mutatis mutandis.

In certain embodiments, the fibre cloth, sheet, or tube has a thickness ranging from 0.2 to 2 mm, such as from 0.3 to 1.0 mm. In certain embodiments, the fibre cloth, sheet, or tube has an average thickness ranging from 0.2 to 2 mm, such as from 0.3 to 1.0 mm. In certain embodiments, the fibre cloth, sheet, or tube has a median thickness ranging from 0.3 to 2 mm, such as from 0.3 to 1.0 mm. The skilled person will understand that filter thickness can be adjusted according to the required needs, and may for instance be dependent on flow rate, pressure drop, etc. In certain embodiments, more than one fibre cloth, sheet, or tube is used, such as at least two fibre cloths, sheets, or tubes. In certain embodiments, two fibre cloths, sheets, or tubes are used. The skilled person will understand that the multiple fibre cloths, sheets, or tubes may be superimposed or foreseen in a layered configuration. The multiple fibre cloths, sheets, or tubes may have different functional and/or structural characteristics. In certain embodiments, two fibre cloths, sheets, or tubes are used wherein a first fibre cloth, sheet, or tube adsorbs polar VOCs and a second first fibre cloth, sheet, or tube adsorbs non-polar VOCs In certain embodiments, the fibre cloth, sheet, or tube has a porosity ranging from 50 to 95%, such as from 70 to 90% (determined as the volume percentage of voids over the total volume, such as determined according to ISO 15901-1:2021). The skilled person will understand that filter porosity can be adjusted according to the required needs, and may for instance be dependent on flow rate, pressure drop, etc.

In certain embodiments, the fibre cloth, sheet, or tube has a (air) permeability ranging from 20 to 300 cm³/cm²/s at 10 mm W.G., such as 50 to 150 cm³/cm²/s at 10 mm W.G. (determined as the air flow rate across the filter over a specific area, such as determined according to ISO 9237:1995). The skilled person will understand that filter permeability can be adjusted according to the required needs, and may for instance be dependent on the required flow rate, volume of the building, etc.

In certain embodiments, the fibre cloth, sheet, or tube has a thickness ranging from 0.2 to 2 mm, such as from 0.5 to 1.5 mm and a porosity ranging from 10 to 70%, such as from 20 to 50%. In certain embodiments, the fibre cloth, sheet, or tube has an average thickness ranging from 0.2 to 2 mm, such as from 0.5 to 1.5 mm and a porosity ranging from 10 to 70%, such as from 20 to 50%. In certain embodiments, the fibre cloth, sheet, or tube has a median thickness ranging from 0.2 to 2 mm, such as from 0.5 to 1.5 mm and a porosity ranging from 10 to 70%, such as from 20 to 50%.

In certain embodiments, the fibre cloth, sheet, or tube has a thickness ranging from 0.2 to 2 mm, such as from 0.5 to 1.5 mm and a (air) permeability ranging from 20 to 300 cm³/cm²/s at 10 mm W.G., such as 50 to 150 cm³/cm²/s at 10 mm W.G. (determined as the air flow rate across the filter over a specific area, such as determined according to ISO 9237:1995). In certain embodiments, the fibre cloth, sheet, or tube has an average thickness ranging from 0.2 to 2 mm, such as from 0.5 to 1.5 mm and a (air) permeability ranging from 20 to 300 cm³/cm²/s at 10 mm W.G., such as 50 to 150 cm³/cm²/s at 10 mm W.G. (determined as the air flow rate across the filter over a specific area, such as determined according to ISO 9237:1995). In certain embodiments, the fibre cloth, sheet, or tube has a median thickness ranging from 0.2 to 2 mm, such as from 0.5 to 1.5 mm and a (air) permeability ranging from 20 to 300 cm³/cm²/s at 10 mm W.G., such as 50 to 150 cm³/cm²/s at 10 mm W.G. (determined as the air flow rate across the filter over a specific area, such as determined according to ISO 9237:1995).

In certain embodiments, the fibre cloth, sheet, or tube has a porosity ranging from 10 to 70%, such as from 20 to 50% and a (air) permeability ranging from 20 to 300 cm³/cm²/s at 10 mm W.G., such as 50 to 150 cm³/cm²/s at 10 mm W.G. (determined as the air flow rate across the filter over a specific area, such as determined according to ISO 9237:1995).

In certain embodiments, the fibre cloth, sheet, or tube has a thickness ranging from 0.2 to 2 mm, such as from 0.5 to 1.5 mm and a porosity ranging from 10 to 70%, such as from 20 to 50% and a (air) permeability ranging from 20 to 300 cm³/cm²/s at 10 mm W.G., such as 50 to 150 cm³/cm²/s at 10 mm W.G. (determined as the air flow rate across the filter over a specific area, such as determined according to ISO 9237:1995). In certain embodiments, the fibre cloth, sheet, or tube has an average thickness ranging from 0.2 to 2 mm, such as from 0.5 to 1.5 mm and a porosity ranging from 10 to 70%, such as from 20 to 50% and a (air) permeability ranging from 20 to 300 cm³/cm²/s at 10 mm W.G., such as 50 to 150 cm³/cm²/s at 10 mm W.G. (determined as the air flow rate across the filter over a specific area, such as determined according to ISO 9237:1995). In certain embodiments, the fibre cloth, sheet, or tube has a median thickness ranging from 0.2 to 2 mm, such as from 0.5 to 1.5 mm and a porosity ranging from 10 to 70%, such as from 20 to 50% and a (air) permeability ranging from 20 to 300 cm³/cm²/s at 10 mm W.G., such as 50 to 150 cm³/cm²/s at 10 mm W.G. (determined as the air flow rate across the filter over a specific area, such as determined according to ISO 9237:1995).

Filter regeneration in certain embodiments is effected by heating at least the filter module, such as to allow desorption of at least the VOC. Desorbed VOC can then subsequently be removed by the filter regeneration module. In certain embodiments, such removal includes breakdown, i.e. chemical destruction or conversion, of VOC, such as by photocatalytic oxidation, as described herein elsewhere. In certain embodiments, the filter regeneration module comprises a photocatalytic oxidation reactor (PCO).

In certain embodiments, the photocatalytic reactor comprises a longitudinal housing having a wall and comprising an inlet and an outlet for allowing air or gas to pass through along the longitudinal direction of the longitudinal housing. The system may also comprise a plurality of tubes or plates positioned in the longitudinal housing and arranged such that some outer tubes, plates, or beads are positioned closer to the housing wall than some inner tubes, plates, or beads. In an embodiment, the plurality of tubes having their longitudinal axis parallel with the longitudinal axis of the longitudinal housing allowing the air or gas to pass along and through said tubes. The tubes, plates, or beads furthermore comprising photocatalytic material in or on their walls. The system furthermore comprises an irradiation system for irradiating the photocatalytic material for inducing catalytic action. The irradiation system and plurality of tubes, plates or beads are configured so that upon irradiating by the irradiation system photocatalytic material of said tubes, plates, or beads is irradiated. It will be understood that when reference is made herein to a deactivated or decoupled filter regeneration module, the irradiation system is inactive. The skilled person will understand that in case plates are used, these may be jagged to increase contact surface.

In certain embodiments, the photocatalytic reactor comprises
a longitudinal housing, the longitudinal housing having a wall and comprising an inlet and an outlet for allowing air or gas to pass through along the longitudinal direction of the longitudinal housing,
a plurality of tubes, plates, or beads positioned in the longitudinal housing and arranged such that some outer tubes, plates, or beads are positioned closer to the housing wall than some inner tubes, plates, or beads, in certain embodiments said plurality of tubes having their longitudinal axis parallel with the longitudinal axis of the longitudinal housing allowing said air or gas to pass along and through said tubes, said tubes, plates, or beads furthermore comprising photocatalytic material in or on their walls, and
an irradiation system for irradiating the photocatalytic material for inducing catalytic action, wherein the irradiation system and plurality of tubes, plates, or beads are configured so that upon irradiating by the irradiation system photocatalytic material of said tubes, plates, or beads is irradiated.

The photocatalytic material may be a coating on the tube, plate, or bead walls. The photocatalytic material may be embedded in the walls of the tubes, plates, or beads. The wall of the housing may be transparent, for example when radiation sources outside the housing are used for inducing the photocatalytic effect. The irradiation system may be a UV source, e.g. a UV-A and/or UV-C irradiation source.

The tubes, plates, or beads may be glass tubes, plates, or beads. The tubes, plates, or beads may be made of sodium free glass. It is an advantage of preferable embodiments that tubes, plates, or beads are used suitable for good sticking properties between the photocatalytic material and the tubes, plates, or beads.

The photocatalytic material applied may be applied using a method of applying photocatalytic material comprising a calcination step.

The cross-section of the tubes, plates, or beads may be any or a combination of circular, elliptical or polygonal. There even may be irregularity in the cross-sections. The tubes, plates, or beads do not need to have a constant cross-section. Not all tubes, plates, or beads need to have the same cross-section.

The tubes may be geometrically arranged such that the outer walls of the tubes form feedthroughs for air or gas to pass. For each feedthrough, the cross-sectional area may be between 0.5 and 1.5 of the average cross-sectional area of the tubes. It is an advantage of preferred embodiments that both inner sides and outer sides of the tubes can be used efficiently for photocatalytic reaction, since the pressured drop is substantially equal both in the tubes as in the feedthrough in between the claims.

The irradiation system also may comprise reflectors for guiding radiation towards the photocatalytic material.

As indicated above the walls of the housing may be transparent or at least partly transparent for activation radiation stemming from outside the housing. Alternatively, if the full irradiation system is internal of the housing, the walls of the housing may be reflective such that radiation reaching the walls is back-reflected towards the tubes, plates, or beads.

The number of tubes in the longitudinal housing may be four or more.

The tubes, plates, or beads may be made of a material that is at least partly transparent for irradiation of said irradiation system. The tubes, plates, or beads may be made of glass or quartz, such as for example borosilicate glass, although embodiments are not limited thereto. For example, also plastics that are UV transparent could be used, or any other type of material that is UV transparent and can be coated with the photocatalyst, prior or after coating.

Because of the transparency of the tubes, plates, or beads, photocatalytic material on or in inner tubes, plates, or beads also can be irradiated.

The photocatalytic material may be positioned at an inner wall of the tubes, at an outer wall of the tubes or both at an inner wall and an outer wall of the tubes. The photocatalytic material may be positioned at one side of the plates or at both sides of the plates. The beads may be porous or non-porous.

The tubes, plates, or beads may be stacked in a closed stacking configuration. It is an advantage of preferred embodiments that a large active surface may be obtained for photocatalytic reaction. The irradiation system may comprise one or more UV sources positioned outside the longitudinal housing.

The irradiation system may comprise at least two UV sources being positioned at opposite sides outside the housing. The irradiation sources may be elongated irradiation sources positioned substantially parallel with the longitudinal housing.

The irradiation system may comprise longitudinal irradiation sources positioned in the housing in between at least some outer tubes, plates, or beads and at least some inner tubes, plates, or beads.

The longitudinal irradiation sources may comprise optical fibres in between at least some outer tubes, plates, or beads and at least some inner tubes, plates, or beads, said optical fibres being arranged for guiding irradiation from an irradiation source couplable or in connection thereto.

The photocatalytic material may comprise titaniumdioxide. Other examples of possible photocatalytic materials are ZnO, CuₓO, Fe₂O₃, CdS, GaP, ZnS, WO₃, etc.

A particularly well-suited embodiment of a photocatalytic reactor for use in an embodiment of the invention is described in WO 2019/002430, the contents of which are incorporated herein in its entirety.

In certain embodiments, the filter module and the regeneration module are comprised or enclosed in a single housing and/or are in fluid connection.

In certain embodiments, the filter module and the regeneration module are configured to allow circulation of air between both. In certain embodiments, the filter module and the regeneration module are configured to allow circulation of air between both in one direction only. In certain embodiments, the air treatment system comprises a check valve (i.e. a one-way valve) configured such that input air cannot bypass the filter module (i.e. input air cannot leave the air treatment system unfiltered by passing though the filter regeneration module instead of the filter module or without passing through the filtration module.

In certain embodiments, the air treatment system comprises means for desorbing VOC from the filter. Advantageously, VOC may be desorbed from the filter by means of thermal desorption, in particular in case the filter is an (activated) carbon filter. Accordingly, in certain embodiments, the means for desorbing VOC from the filter comprise means for temperature elevation.

In certain embodiments, the air treatment system comprises a heating element. Alternative embodiments making use of any type of suitable heating element are possible. The heating element may be configured to heat the entire air treatment system, and serves to desorb VOC from the filter. Accordingly, the heating element should at least be capable of heating the filter module to a temperature allowing desorption of the VOC, such as at least 50 °C or at least 75 °C.

In certain embodiments, the air treatment system as described herein advantageously and synergistically combines the use of the filter module and the filter regeneration module. The air processing circuit may advantageously be configured such that input air is filtered by the filter module and the filter regeneration module is inactive and/or decoupled from the filter module. When the filter is saturated, the filter regeneration module is activated and/or coupled to the filter module, VOC are desorbed from the filter module, and subsequently mineralized/oxidized. In this way, the filter is regenerated. This has as a main advantage that filters can be reused and hence need not be replaced as frequently. On the other hand, by only activating the filter regeneration module once the filter is saturated, a significant reduction in energy consumption is achieved. Moreover, in particular photocatalytic oxidation reactors operate most efficiently when high concentrations of VOC are present, such as is the case after desorption from the filter. This timely coupling of the filter module and filter regeneration module therefore synergistically increases filtration efficiency, while reducing costs.

In certain embodiments, the air treatment system as described herein comprises a ventilator or a fan. This is particularly advantageous in the filter regeneration mode, during which external ventilators or fans are decoupled from the system as entry and exit of respectively input air and output air is not accepted. According to a preferred embodiment the ventilator or fan is heat-resistant, as will be described in further detail below.

In certain embodiments, the air treatment system as described herein comprises a valve system. The valve system may comprise at least two valves, respectively configured allow or prevent acceptance of input air and to allow or prevent outputting of (filtered) air. Optionally a third valve may be present, such as the check valve described herein elsewhere, which ensures unidirectional circulation of the air inside the air treatment system.

In certain embodiments, the air treatment system as described herein comprises a controller. Such controller may be configured to control activation and deactivation of the air purification mode and the filter regeneration mode. Such controller may be configured to control coupling and decoupling of the filter module and the filter regeneration module. Such controller may be configured to control activation and deactivation of the air purification mode and the filter regeneration mode as well as coupling and decoupling of the filter module and the filter regeneration module. Such controller may be configured to control the valve system. Such controller may be configured to control the means for desorbing VOC from the filter. Such controller may be configured to control activation and deactivation of the air purification mode and the filter regeneration mode and/or to control coupling and decoupling of the filter module and the filter regeneration module, to control the means for desorbing VOC from the filter, and to control the valve system. In particular, the controller may be configured to alternate between the air purification mode and the filter regeneration mode.

In certain embodiments, the controller is operated manually. In such case, the filter regeneration module, valve system, and means for desorbing VOC from the filter are simultaneously or sequentially, but manually activated or deactivated.

Preferably however, the controller is operated automatically. In certain embodiments, the controller allows timer-based alternation between the air purification mode and the filter regeneration mode. In certain embodiments, the controller allows timer-based activation and deactivation of the air purification mode and the filter regeneration mode. In certain embodiments, the controller allows timer-based coupling and decoupling of the filter module and the filter regeneration module. In certain embodiments, the controller allows timer-based activation and deactivation of the air purification mode and the filter regeneration mode as well as coupling and decoupling of the filter module and the filter regeneration module. In certain embodiments, the controller allows timer-based operation of the valve system In certain embodiments, the controller allows timer-based operation of the means for desorbing VOC from the filter. In certain embodiments, the controller allows timer-based activation and deactivation of the air purification mode and the filter regeneration mode and/or coupling and decoupling of the filter module and the filter regeneration module, operation of the means for desorbing VOC from the filter, and operation of the valve system.

In certain embodiments, the controller allows sensor-based alternation between the air purification mode and the filter regeneration mode. In certain embodiments, the controller allows sensor-based activation and deactivation of the air purification mode and the filter regeneration mode. In certain embodiments, the controller allows sensor-based coupling and decoupling of the filter module and the filter regeneration module. In certain embodiments, the controller allows sensor-based activation and deactivation of the air purification mode and the filter regeneration mode as well as coupling and decoupling of the filter module and the filter regeneration module. In certain embodiments, the controller allows sensor-based operation of the valve system In certain embodiments, the controller allows sensor-based operation of the means for desorbing VOC from the filter. In certain embodiments, the controller allows sensor-based activation and deactivation of the air purification mode and the filter regeneration mode and/or coupling and decoupling of the filter module and the filter regeneration module, operation of the means for desorbing VOC from the filter, and operation of the valve system. In certain embodiments, the sensor is a VOC sensor. Such sensors are well-known in the art, and include without imitation tin dioxide and titanium dioxide based sensors. A sensor may for instance be provided downstream of the filter module. If the VOC concentration exceed a certain minimal threshold concentration (indicative of saturation of the filter), the air filter regeneration mode is activated. Alternatively, air filter regeneration mode activation may be effected based on a minimal threshold difference in VOC concentration upstream and downstream of the filter module (likewise indicative of filter saturation). The skilled person will understand that such thresholds may be determined empirically or may be fixed, dependent on the required level of purification.

According to a preferred embodiment, the air treatment system is heat-resistant, i.e. according to preferred embodiments all components of the air treatment system as described herein are heat resistant, such as without limitation the filter module, the regeneration module, the valve system, etc. The skilled person will understand that components need only be heat resistant in so far as these may be subjected to heat, i.e. reside in the housing of the air treatment system. For instance a sensor may partly reside inside and partly outside the air treatment housing. The skilled person will understand that at least the part residing inside the air treatment system need be heat resistant. As used herein, the term heat-resistant implies that the air treatment system and its components are capable of withstanding temperatures of at least 50 °C, such as at least 75 °C, without resulting in structural and/or functional damage, i.e. after exposure to temperatures of at least 50 °C, such as for instance at temperatures capable of desorbing VOC from the filter, i.e. the regeneration mode, the air treatment system maintains its capability to adsorb VOC again, i.e. the air purification mode. In certain embodiments, the air treatment system is resistant to heat at a temperature which is at least the temperature at which desorption of VOC occurs, which may be at least 50 °C or at least 75 °C.

According to a second aspect, there is provided a method of operating an air treatment system according to the first aspect, wherein the method comprises the steps of:

selectively operating the air processing circuit in:
an air purification mode, during which the air processing circuit:
   accepts the input air and feeds the input air to the filter module, and
   provides the filtered output air by feeding the filtered air from the filter module; and
a filter regeneration mode, during which the air processing circuit:
   does not accept the input air and does not provide the filtered output air, and
couples the filter module to the filter regeneration module, whereby the filter regeneration module is operated to remove and/or reduce at least a part of the accumulated volatile organic compounds from the filter module.

In certain embodiments, the air processing circuit is operated/controlled by the controller, as described herein elsewhere, and may control the filter regeneration module, the means for desorbing the VOC, the ventilator/fan and/or the valve system.

In certain embodiments, the method is a computer-implemented method.

According to a third aspect, there is provided a ventilation system, heating system, air conditioning system, or HVAC system comprising the air treatment system according to the first aspect.

Advantageously, in certain embodiments, the ventilation system, heating system, air conditioning system, or HVAC system can be configured to be operated in a ventilation mode and an air treatment mode. During the ventilation mode, fresh air may be supplied (e.g. outside air), which may or may not be heated or cooled (for instance in a heating system or air conditioning system). During the air treatment mode, the air treatment system of the invention is operational. It will be understood that the air treatment mode may comprise the air purification mode and the filter regeneration mode, as described herein elsewhere. The functioning of the ventilation mode and/or air treatment mode in the ventilation system, heating system, air conditioning system, or HVAC system may depend on operational parameters as is known in the art. De ventilation mode and air treatment mode may be decoupled (and hence mutually exclusive) as described herein elsewhere (in analogy with the air purification mode and filter regeneration mode of the air treatment system of the invention), such as by valve systems as described herein elsewhere. A controller (such as the controller as described herein elsewhere) may be configured to operate the ventilation system, heating system, air conditioning system, or HVAC system in the ventilation mode and/or the air treatment mode. Operational parameters may determine which mode is active. Switching between ventilation mode and air treatment mode may be as described herein elsewhere, such as for instance manually or automated. Automation may involve time-based control or sensor-based control, as described herein elsewhere (in analogy with the air purification mode and filter regeneration mode of the air treatment system of the invention). By means of example, and without limitation, a CO₂ sensor may be integrated. Upon reaching a minimal CO₂ concentration threshold, the ventilation mode may be active or activated. Below such CO₂ concentration threshold, the air treatment mode may be active or activated. For instance, if no people are present in a room/building, there is no CO₂ build-up, and no ventilation is needed. In such case, the air treatment mode is active/activated and the ventilation mode may be deactivated. By deactivation of the ventilation mode energy consumption may be drastically reduced, as no hot or cold (outside) air is introduced, which may otherwise require additional cooling or heating. Conversely, if people are present in the room/building, CO² concentration increases, ultimately triggering activation of the ventilation mode upon reaching the minimal CO₂ threshold. It will be understood that while in certain embodiments the ventilation mode and air treatment mode are mutually exclusive, such need not always be the case. For instance, the air treatment mode may always be active and the ventilation mode may additionally become activated (such as for instance based on a CO₂ sensor). It will be appreciated that other types of sensors than a CO₂ sensor may be used. The skilled person is well aware of additional sensor types which may probe for human activity/presence in room/building for which the air treatment system is provided.

According to a fourth aspect, there is provided the use of the air treatment system according to the first aspect in a ventilation system, heating system, air conditioning system, or HVAC system.

According to a fifth aspect, there is provided a data processing device comprising means for carrying out the steps of the method of the second aspect. In certain embodiments, the data processing device is comprised in the controller. In particular, the data processing device may be configured to select between the air purification mode and the filter regeneration mode, such as by means of the automatic time-based or sensor-based criteria as described herein elsewhere.

According to a sixth aspect, there is provided a computer program product comprising instructions which, when the program is executed by a computer, cause the computer to carry out the method of the second aspect. In particular, the computer program product may comprise instructions to select between the air purification mode and the filter regeneration mode, such as by means of the automatic time-based or sensor-based criteria as described herein elsewhere.

According to a seventh aspect, there is provided a computer-readable data carrier comprising instructions which, when the executed by a computer, cause the computer to carry out the method of the second aspect. In particular, the data carrier may comprise instructions to select between the air purification mode and the filter regeneration mode, such as by means of the automatic time-based or sensor-based criteria as described herein elsewhere.

It will be understood from the above that the present systems are typically envisaged for the treatment of the air in a given space or room. Typically, by way of the air-treatment systems of the invention, air is extracted from the space or room and used as input air in the system. Additionally or alternatively, the air is taken from a source of outside air, which is in need of treatment by the air treatment system before being fed into a space or room. In particular embodiments, the output air is fed to the same space or room from which the input air is extracted for treatment by the air treatment system. According to alternative embodiments, the filtered output air is returned to the source of outside air, and then fed into a space or room. It is clear that still further alternative embodiments are possible, in which for example the input air originates from any suitable indoor and/or outdoor space in which for example volatile pollutants are present, which is then filtered by the air treatment system according to the invention before being released into an indoor or outdoor space. The invention thus also provides a set up of the air-treatment systems of the invention in a space or room or outside of said space or room, with connections for input of air in need of treatment and output of treated air to the inside or outside of said space or room, as appropriate. In particular embodiments, the air treatment system of the invention in the set-up is configured to select between the air purification mode and the filter regeneration mode or the air, using time-based or sensor-based criteria as described herein elsewhere.

### EXAMPLES

### Example 1

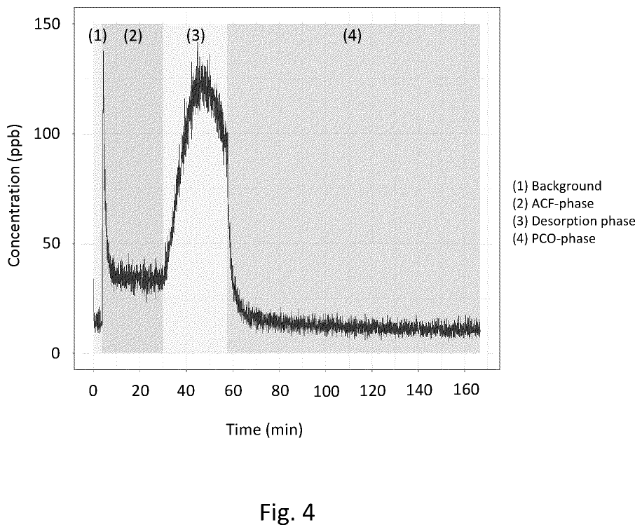

Acetaldehyde was used as a model VOC in the experiment. A reactor according to the invention was placed in a 1.2 m³ climate chamber which was used to homogenize the air prior to the start of the experiment. Acetaldehyde was injected into the chamber and the concentration was monitored to ensure that there were no leakages. The acetaldehyde concentration in air was measured via selected ion flow tube mass spectrometry (Syft™ technologies). To demonstrate the efficacy of the reactor and its different modes of operation, the acetaldehyde concentration inside the reactor was monitored during the experiment (see FIG. 4). First, a background concentration inside the reactor was established which is as low as 25 ppb (parts per billion). Next, in the ACF (activated carbon filter) phase, the polluted air is led over the filter and adsorption onto the activated carbon takes place. The ACF was able to efficiently capture a significant amount of the injected acetaldehyde and an equilibrium was quickly established at around 30 ppb. Next, the reactor was switched to the regeneration loop and the air inside the reactor was heated to 80 °C by a PTC heating element. In the desorption phase, the gradually increasing air temperature promotes desorption of acetaldehyde and an increase in VOC concentration to up to 130 ppb was observed. Lastly, the UV-A lamps in the photocatalytic reactor were turned on. A rapid decrease in acetaldehyde concentration due to the photocatalytic oxidation (PCO) of acetaldehyde was observed. It has been shown that the PCO module is able to efficiently mineralize the desorbed acetaldehyde and consequently reaches a minimum concentration of 25 ppb in 30 minutes.

### Example 2

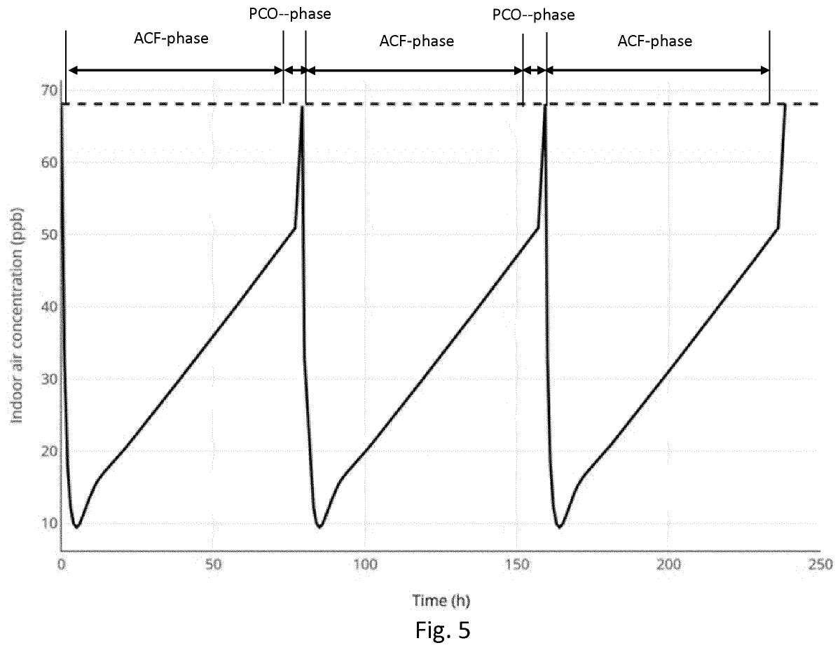

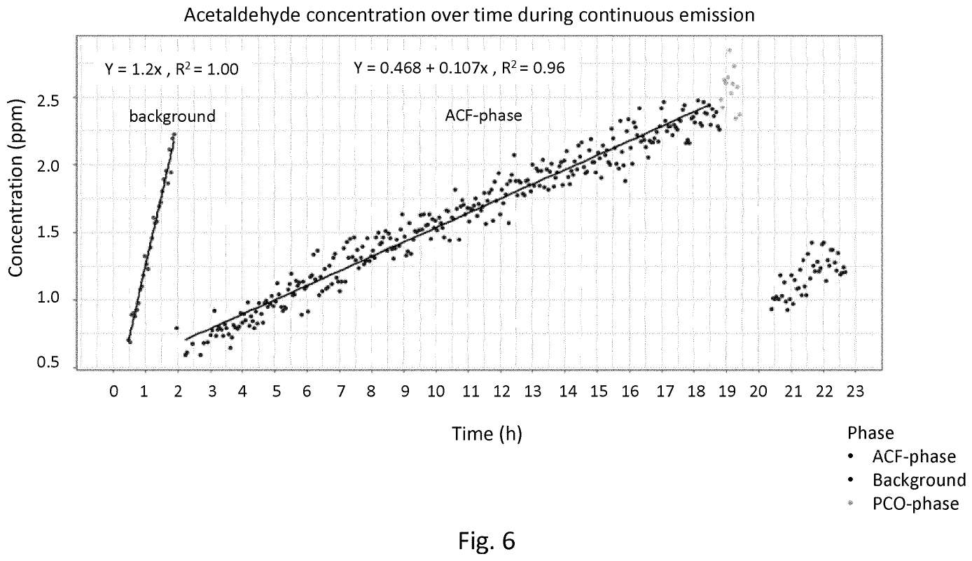

FIGS. 5 and 6 respectively show simulated and experimental pollutant concentration curves obtained when using an air treatment device according to the invention. The device is able to effectively clean the air through the active carbon filter (ACF)-unit and significantly reduce the rate at which pollutant concentration increases (ACF-phase). The filter is regenerated in 30-60 min by thermal desorption of the pollutants and converted into CO₂ (photocatalytic oxidation (PCO)-phase). At this point, the ACF-unit is free of pollutants and the device can be switched into the ACF-phase to repeat the filter-generation cycle.

### Example 3

The air treatment system has two operational configurations. Initially, contaminated air is directed through a pleated ACF unit, facilitating the adsorption of VOCs for immediate purification. Upon saturation of the ACF unit, the ventilation system transitions into a closed-loop configuration, incorporating both the ACF unit and a photocatalytic multi-tube reactor. Thermal desorption is utilized to revert the VOCs back into the gas phase, followed by their efficient degradation within the photocatalytic reactor. This process continues until the ACF unit is regenerated, enabling the iterative cycle of purification and regeneration.

VOC degradation experiments were carried out in a 1.2 m³ climate chamber to test the effectiveness of the air treatment system. VOC concentrations were measured with a selected ion flow tube mass spectrometer, enabling real-time response and accuracy up to ppb level.

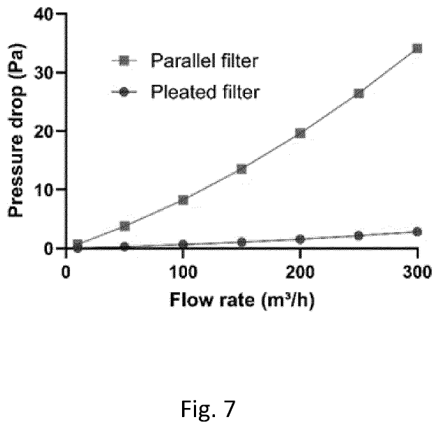

Because of its pleated design, the total active carbon volume could be increased 14 times compared to a conventional parallel filter, simultaneously reducing the pressure drop over the system significantly (FIG. 7). Additionally, energy consumption could be reduced by 64% compared to an ordinary photocatalytic reactor by employing the two-phase purification-regeneration cycle.

The photocatalytic reactor was able to effectively degrade acetaldehyde and toluene, two conventional model VOCs for polar and apolar compounds, respectively. The ACF unit could effectively provide clean air for an extended period before needing to be regenerated. In its purification mode, the ACF unit could decrease VOC build up to up to 10 times during continuous acetaldehyde emission. Based on experimental results, it was found that the optimal configuration of the reactor was 10h air purification followed by 30 min filter regeneration.

1. An air treatment system (10) for filtering volatile organic compounds, the air treatment system (10) comprising an air processing circuit (100) for receiving input air (110) and outputting filtered output air (120), the air processing circuit (100) comprising:
a filter module (200) configured to remove volatile organic compounds; and
a filter regeneration module (300) comprising one or more photocatalytic reactors, and
the air processing circuit (100) configured to be selectively operatable in:
an air purification mode (130), during which the air processing circuit (100) is configured:
to accept the input air (110) and feed the input air (110) to the filter module (200), and
to feed filtered air from the filter module (200) to provide the filtered output air (120); and
a filter regeneration mode (140), during which the air processing circuit (100) is configured:
not to accept the input air (110) and not to provide the filtered output air (120), and
to couple the filter module (200) to the filter regeneration module (300), whereby the filter regeneration module (300) is operated to remove and/or reduce at least a part of accumulated volatile organic compounds from the filter module (200).

2. The air treatment system of claim 1, wherein the air processing circuit (100) is further configured such that:
in the air purification mode (130) the filter regeneration module (300) is:
deactivated;
decoupled from the filter module (200); and/or
decoupled from the input air (110) and/or the filtered output air (120); and
in the filter regeneration mode (140) the filter regeneration module (300) is:
activated;
coupled to the filter module (200); and/or
decoupled from the input air (110) and/or the filtered output air (120).

3. The air treatment system of claim 1, wherein the air processing circuit (100) is further configured such that:
in the air purification mode (130) the filter module (200) is:
decoupled from the filter regeneration module (300); and/or
coupled to the input air (110) and/or the filtered output air (120); and
in the filter regeneration mode (140) the filter module (200) is:
coupled to the filter regeneration module (300); and/or
decoupled from the input air (110) and/or the filtered output air (120).

4. The air treatment system of claim 1, wherein the air processing circuit (100) comprises a valve system (150,160) coupled to the filter module (200) and the filter regeneration module (300), and configured such that:
in the air purification mode (130) the valve system (150, 160) is set in a first state, in which the valve system (150, 160):
decouples the filter module (200) from the filter regeneration module (300); and/or
couples the filter module (200) to the input air (110) and/or the filtered output air (120); and
in the filter regeneration mode (140) the valve system (150, 160) is set in a second state, in which the valve system (150, 160):
couples the filter module (200) to the filter regeneration module (300); and/or
decoupled the filter module (200) from the input air (110) and/or the filtered output air (120).

5. The air treatment system of claim 1, comprising a controller (400) configured to control activation and deactivation of the air purification (130) mode and the filter regeneration mode (140) and/or configured to control coupling and decoupling of the filter module (200) and the filter regeneration module (300).

6. The air treatment system of claim 5, wherein the air processing circuit (100) comprises a valve system (150,160) coupled to the filter module (200) and the filter regeneration module (300), and configured such that:
in the air purification mode (130) the valve system (150, 160) is set in a first state, in which the valve system (150, 160):
decouples the filter module (200) from the filter regeneration module (300); and/or
couples the filter module (200) to the input air (110) and/or the filtered output air (120); and
in the filter regeneration mode (140) the valve system (150, 160) is set in a second state, in which the valve system (150, 160):
couples the filter module (200) to the filter regeneration module (300); and/or
decoupled the filter module (200) from the input air (110) and/or the filtered output air (120); and
wherein the controller (400) is configured to control the valve system (150, 160), particular-to switch between the first state and the second state.

7. The air treatment system of claim, wherein the controller (400) is configured to be operated manually or automatically.

8. The air treatment system of claim 7, wherein the controller (400) is configured for timer-based or sensor-based activation and deactivation of the air purification (130) mode and the filter regeneration mode (140) and/or coupling and decoupling of the filter module (200) and the filter regeneration module (300).

9. The air treatment system of claim 1, wherein the filter module comprises one or more carbon filters.

10. The air treatment system of claim 9, comprising means for desorbing volatile organic compounds from the one or more carbon filters.

11. The air treatment system of claim 10, wherein the means for desorbing volatile organic compounds from the one or more (activated) carbon filters is a heating element.

12. The air treatment system of claim 10, wherein the means for desorbing volatile organic compounds from the one or more carbon filters and the photocatalytic (oxidation) reactor are controlled by a controller (400) and are activated only in the filter regeneration mode (140).

13. The air treatment system of claim 1, wherein the air treatment system is comprised in ventilation system, heating system, air conditioning system, or HVAC system.

14. A method of operating an air treatment system (10) of claim 1, wherein the method comprises the steps of:
selectively operating the air processing circuit (100) in:
an air purification mode (130), during which the air processing circuit (100):
accepts the input air (110) and feeds the input air (110) to the filter module (200), and
provides the filtered output air (120) by feeding the filtered air from the filter module (200); and
a filter regeneration mode (140), during which the air processing circuit (100):
does not accept the input air (110) and does not provide the filtered output air (120), and
couples the filter module (200) to the filter regeneration module (300), whereby the filter regeneration module (300) is operated to remove and/or reduce at least a part of accumulated volatile organic compounds from the filter module (200).

15. A data processing device, when connected to an air treatment system of claim 1, comprising means for carrying out the steps of selectively operating the air processing circuit (100) in:
an air purification mode (130), during which the air processing circuit (100):
accepts the input air (110) and feeds the input air (110) to the filter module (200), and
provides the filtered output air (120) by feeding the filtered air from the filter module (200); and
a filter regeneration mode (140), during which the air processing circuit (100):
does not accept the input air (110) and does not provide the filtered output air (120), and
couples the filter module (200) to the filter regeneration module (300), whereby the filter regeneration module (300) is operated to remove and/or reduce at least a part of the accumulated volatile organic compounds from the filter module (200);
and/or a computer program product comprising instructions which, when the program is executed by a computer, when connected to an air treatment system of claim 1, cause the computer to carry out the steps; and/or a computer-readable data carrier comprising instructions which, when the executed by a computer, cause the computer, when connected to an air treatment system of claim 1, to carry out the steps.

16. The air treatment system of claim 1, wherein the one or more photocatalytic reactors is one or more photocatalytic oxidation reactors.

17. The air treatment system of claim 9, wherein the one or more carbon filters comprise one or more activated carbon filters.
